(19) United States
(12) Patent Application Publication
(10) Pub. No.: US 2009/0030887 A1
(43) Pub. Date: Jan. 29, 2009

(54) RECORDING MEDIUM IN WHICH COLLATION PROCESSING PROGRAM IS STORED, COLLATION PROCESSING DEVICE AND COLLATION PROCESSING METHOD

(75) Inventors: Tatsuya ASAI, Kawasaki (JP); Seishi OKAMOTO, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/179,212

(22) Filed: Jul. 24, 2008

(30) Foreign Application Priority Data
Jul. 26, 2007 (JP) 2007-195081

(51) Int. Cl. G06F 17/30

(52) U.S. Cl. 707/4; 707/E17.136

(57) ABSTRACT

A collation processing device has a document storage unit, axis transforming unit, automaton creating unit, and collating processing unit. The document storage unit stores document data having a hierarchical structure in which elements are sectioned by element identifiers. The axis transforming unit executes axis transformation on a search formula when the search formula is obtained, whereby the search formula concerned is transformed to a search formula constructed of child axes. The automaton creating unit identifies the type of element identifiers contained in the transformed search formula to create the automaton corresponding to the search formula concerned. The collating processing unit collates data contained in the document data with the automaton to output the data corresponding to the search formula.

### BACKGROUND

1. Technical Field

The embodiments relate to a collation processing technique that can search data corresponding to a search formula from document data having a hierarchical structure, irrespective of the structure of the search formula when the data corresponding to the search formula concerned are searched from the document data having the hierarchical structure in which elements are sectioned by element identifiers.

2. Description of the Related Art

XML (Extensible Markup Language) or the like has been recently used to process document data in a computer. XML has a hierarchical structure using element identifiers “<”, “/”, etc. to be referred to as tags, and it can contain a larger amount of information as compared with a text style. Therefore, XML has been more frequently used in computers. In the following description, document data having a hierarchical structure described on the basis of XML will be described as XML data.

There is generally known a method of using a search formula such as query (Xpath formula) or the like and searching the document data and node corresponding to the query in order to efficiently search XML data containing a hierarchical structure (for example, JP-A-2004-126933).

Furthermore, in connection with the tremendous increase of XML data, it has also been required to search the document data and node corresponding to a query on the basis of stream processing, without imposing any load on a computer. However, when backward axes or the like are contained in the query, it is difficult to search XML data through stream processing.

FIG. 34 is a diagram showing the problem of the prior art. The reason why it is difficult to search XML data through stream processing will be described. In processing based on stream orientation, data which have been already read cannot be read again. This is because it would be necessary to access past data (D1 of FIG. 34 to Dn−1 (not shown)) which precede the present data position (Dn of FIG. 34) if backward axes are contained in a query.

That is, even when a branch or the like is contained in a query, it is important to efficiently search the document data, etc. corresponding to the query from XML data at high speed.

Therefore, it is an object to search the document data, etc. corresponding to a query from XML data efficiently at high speed, irrespective of the structure of the query.

### SUMMARY

According to an aspect of an embodiment, a collation processing device has a document storage unit, axis transforming unit, automaton creating unit, and collating processing unit. The document storage unit stores document data having a hierarchical structure in which elements are sectioned by element identifiers. The axis transforming unit executes axis transformation on a search formula when the search formula is obtained, whereby the search formula concerned is transformed to a search formula constructed of child axes. The automaton creating unit identifies the type of element identifiers contained in the transformed search formula to create the automaton corresponding to the search formula concerned. The collating processing unit collates data contained in the document data with the automaton to output the data corresponding to the search formula.

### BRIEF DESCRIPTION OF THE DRAWINGS

FIG. 1 is a diagram showing a tree expression of XML data and stream expression of XML data.

FIG. 2 is a diagram showing an example of a query containing backward axes.

FIG. 3 is a diagram showing a search result when the XML data shown in FIG. 1 are searched by a query shown in FIG. 2.

FIG. 4 is a functional block diagram showing the construction of a collation processing device according to an embodiment.

FIG. 5 is a diagram showing an example of the data structure of the XML data.

FIG. 6 is a diagram when the XML data shown in FIG. 5 are expressed by the tree expression.

FIG. 7 is a diagram showing an example of the data structure of a pathtrie.

FIG. 8 is a diagram showing an example of the data structure of each tag shown in FIG. 7.

FIG. 9 is a diagram showing an example of the data structure of a BIN file.

FIG. 10 is a diagram showing an example of a query stored as query data.

FIG. 11 is a diagram showing an example of the data structure of a sibling association table.

FIG. 12 is a diagram showing an example of the data structure of a hit table.

FIG. 13 is a diagram showing an example of the data structure of a stack.

FIG. 14 is a diagram showing a summary of the processing of an axis transforming processor.

FIG. 15 is a diagram for supplementary description of the sibling axis transforming processing.

FIG. 16 is a diagram for supplementary description of the processing of an automaton creator.

FIG. 17 is a diagram showing an example of the data structure of a node structure.

FIG. 18 is a diagram showing an example of the data structure of an event structure.

FIG. 19 is a diagram showing an example of the data structure of a BIN file to describe collation processing.

FIG. 20 is a diagram showing the state of the hit table at the time point when an event E1=(Q1, C, 1003) occurs.

FIG. 21 is a diagram showing the state of the hit table at the time point when an event E2=(Q2, A2, 1004) occurs.

FIG. 22 is a diagram showing the state of the stack at the time point when an event E2=(Q2, A2, 1004) occurs.

FIG. 23 is a diagram showing the state of the hit table at the time point when an event E4=(Q1, C, 1006) occurs.

FIG. 24 is a diagram showing the state of the hit table at the time point when an event E5=(Q1, A2, 1007) occurs.

FIG. 25 is a diagram showing the state of the stack at the time point when an event E5=(Q1, A2, 1007) occurs.

FIG. 26 is a diagram showing the state of the hit table at the time point when an event E7=(Q1, A1, 1009) occurs.

FIG. 27 is a diagram showing the state of the stack at the time point when an event E7=(Q1, A1, 1009) occurs.

FIG. 28 is a flowchart showing the processing flow of the collation processing device according to the embodiment.

FIG. 29 is a flowchart showing axis transforming processing according to the embodiment.

FIG. 30 is a flowchart showing automaton creation processing according to the embodiment.

FIG. 31 is a flowchart showing the collation processing according to the embodiment.

FIG. 32 is a flowchart showing event estimation processing according to this embodiment.

FIG. 33 is a diagram showing hardware construction of a computer equipped to the collation processing device shown in FIG. 4.

FIG. 34 is a diagram showing a problem of the related art.

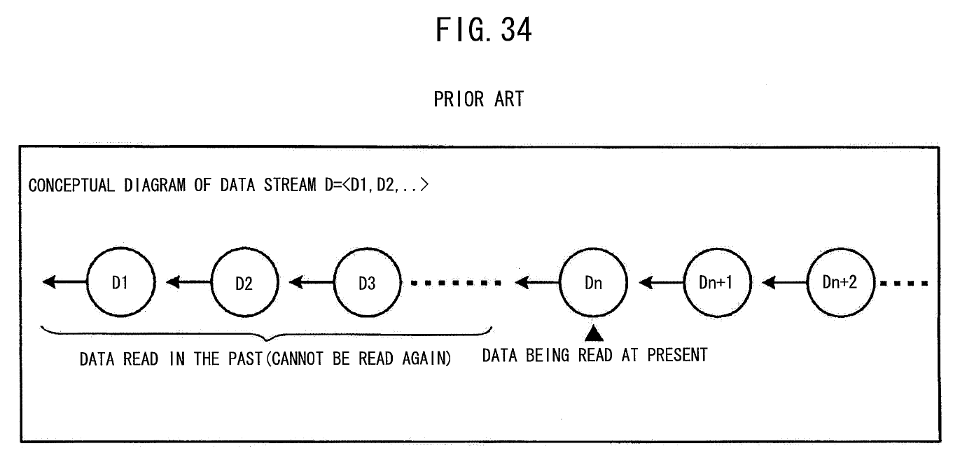

### DETAILED DESCRIPTION OF THE EMBODIMENTS

A preferred embodiment will be described hereunder in detail with reference to the accompanying drawings.

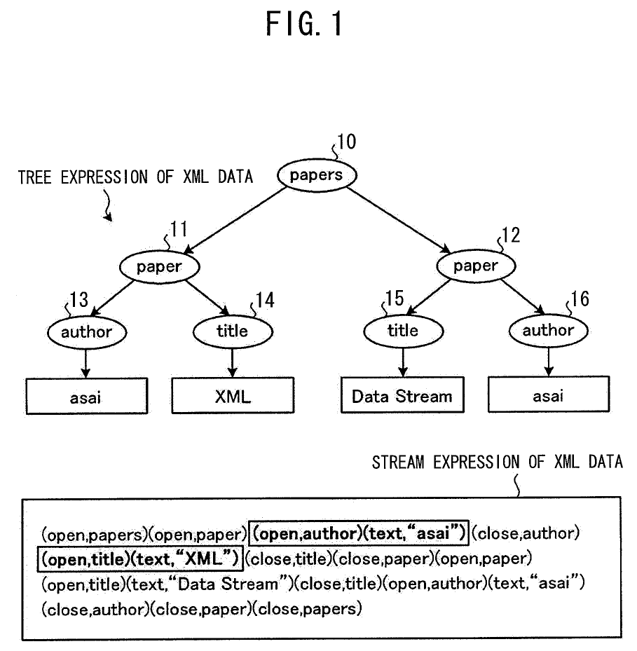

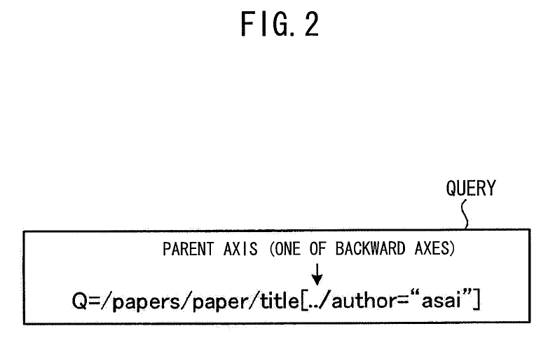

First, XML data and backward axes of a query will be described. FIG. 1 is a diagram showing a tree expression of the XML data and a stream expression of the XML data. FIG. 2 is a diagram showing an example of a query (search formula) containing backward axes.

As shown in FIG. 1, in the tree expression of the XML data, the XML data has respective elements of papers 10, paper 11, 12, author 13, 16, and title 14, 15, and connects the respective elements.

Specifically, papers 10 is connected to paper 11, 12. Paper 11 is connected to author 13 and title 14, and paper 12 is connected to title 15 and author 16. Author 13, author 16 are connected to document data “asai”, title 14 is connected to document data “XML”, and title 15 is connected to document data “Data Stream”.

Here, the relationship between papers 10 and paper 11, 12 is defined as a parent and a child. The relationship between paper 11, 12 is defined as brothers, paper 11 is defined as an elder brother and paper 12 is defined as a younger brother. Likewise, the relationship of paper 11 and author 13, title 14 is defined as a parent and a child. Furthermore, the relationship between author 13 and title 14 is defined as brothers, author 13 is defined as an elder brother and the title 4 is defined as a younger brother.

Furthermore, the relationship of paper 12 and title 15, author 16 is defined as a parent and a child. The relationship between title 15 and author 16 is defined as brothers, title 15 is defined as an elder brother and author 16 is defined as a younger brother. Furthermore, elements connected to the lower side of each element are defined as descendants. For example, descendants of papers 10 are paper 11, paper 12, author 13, author 16, title 14 and title 15.

In the stream expression of the XML data, the respective elements are successively arranged from the axis of the left side of the tree expression of the XML data. When the XML data based on the stream expression are subjected to data search by the query, an advantage is that the amount of memory used may be small and tremendous data can be easily handled. However, data which have been already read cannot be read again. For example, in the XML data based on the stream expression, it is impossible to read (open, author) (text, “asai”) after (open, title) (text, “XML”) is referred to.

Subsequently, shifting to the description of FIG. 2, the meaning of the query shown in FIG. 2 resides in the meaning that the title element just below “paper” and just below “papers” is searched under a restriction condition of [../author=“asai”]. The meaning of the restriction condition that [../author=“asai”} in the case of FIG. 2 resides in the restriction condition that author having document data of “asai” exists just below the parent (in this case, “paper”) of the title element.

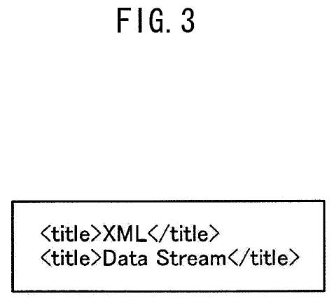

The elements to be searched by the query of FIG. 2 are title 14 and title 15 of FIG. 1, and a search result is displayed as shown in FIG. 3. FIG. 3 is a diagram showing the search result when the XML data of FIG. 1 are searched by the query shown in FIG. 2.

However, the query shown in FIG. 2 requires that the parent axis paper of “title” is referred to after “title” is temporarily referred to (because it contains backward axes), and thus it is difficult to directly search the XML data of FIG. 1 by stream processing. In the example shown in FIG. 2, “../” represents the backward axis.

Next, the collation processing device according to this embodiment will be described. The collation processing device conducts axis transformation on the query containing the backward axes, a branch, etc. on the basis of an axis transforming algorithm, and searches the XML data through stream processing by using the axis-transformed query. As described above, the collation processing device executes the search of the XML data by stream processing after the axis-transformation of the query is carried out, so that the document data, etc. corresponding to the query can be searched from the XML data at high speed and efficiency.

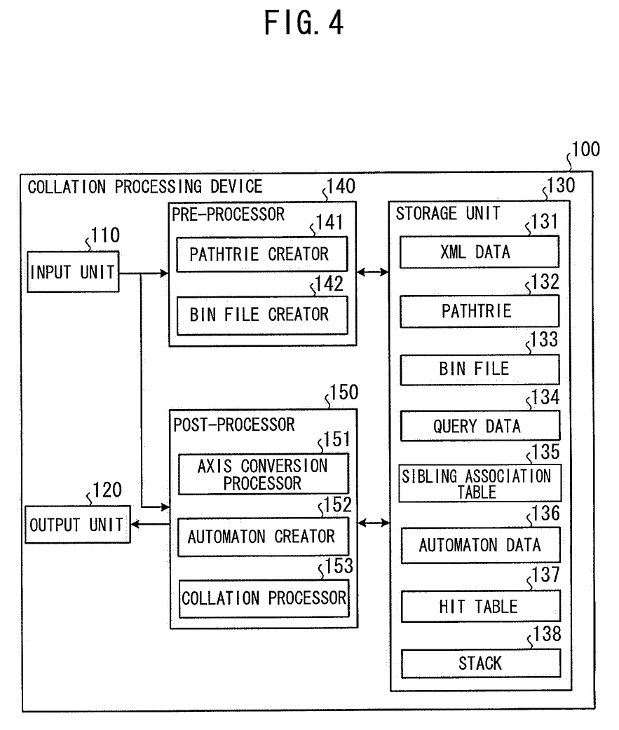

FIG. 4 is a functional block diagram showing the construction of the collation processing device according to this embodiment. As shown in FIG. 4, the collation processing device 100 is equipped with an input unit 110, an output unit 120, a storage unit 130, a pre-processor 140 and a post-processor 150.

The input unit 110 is an input unit for inputting various kinds of information, and it could be a keyboard, a mouse, a microphone, a data reading device or the like and inputs XML data, a query, etc. as described above. The output unit 120 is a unit for outputting various kinds of information (for example, data corresponding to a query), and it could be a monitor (specifically, a display, a touch panel) or the like.

The storage unit 130 is a memory (storage unit) for storing data and programs required for various kinds of processing by the pre-processor 140 and the post-processor 150. Particularly, the storage unit 130 is equipped with XML data 131, a pathtrie 132, a BIN file 133, query data 134, a sibling association table 135, automaton data 136, a hit table 137 and a stack 138.

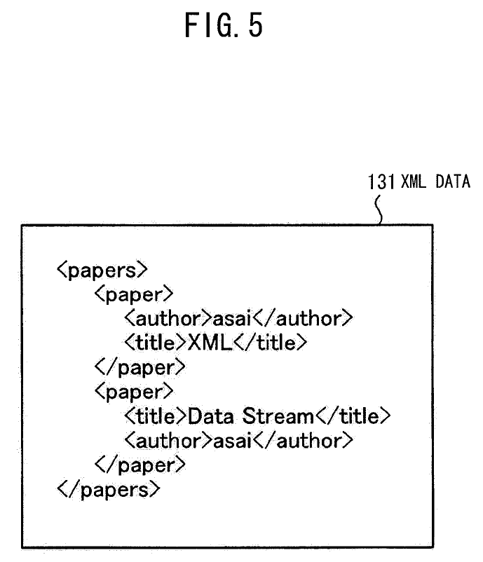

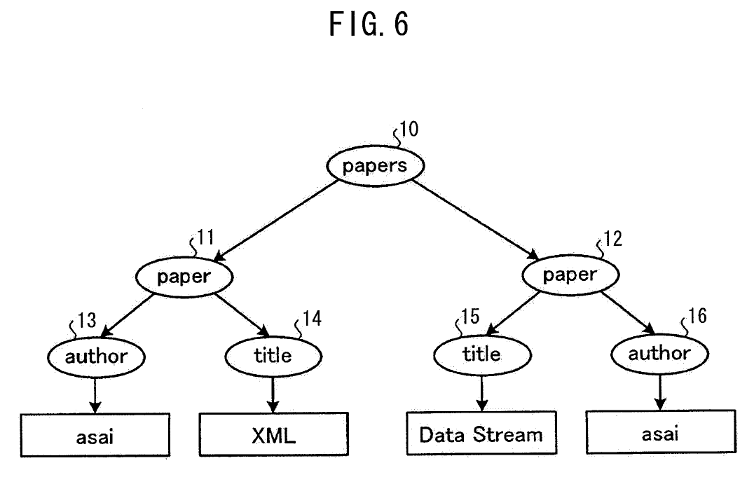

The XML data 131 is document data having a hierarchical structure using element identifiers “<”, “/>”, etc. to be referred to as tags. FIG. 5 is a diagram showing an example of the data structure of the XML data. If the XML data shown in FIG. 5 are represented by the tree expression, it can be illustrated as shown in FIG. 6. FIG. 6 is a diagram when the XML shown in FIG. 5 is expressed by the tree expression. The description made with reference to FIG. 6 is the same as the description associated with the tree expression of FIG. 1, and thus the description thereof is omitted.

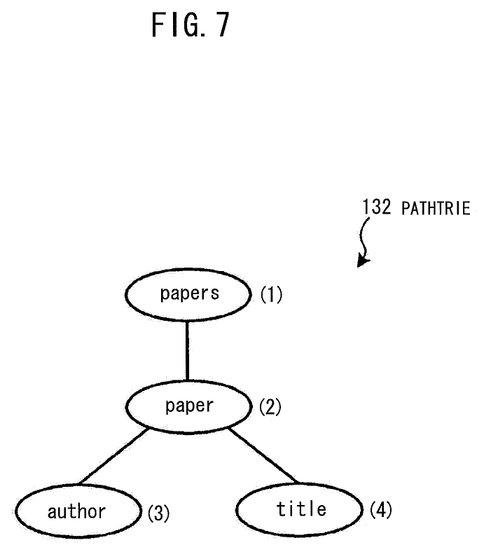

The pathtrie 132 is data in which duplicated paths of the XML data are omitted and unique IDs are allocated to the respective elements of the XML data. FIG. 7 is a diagram showing an example of the data structure of the pathtrie 132. As shown in FIG. 7, the pathtrie 132 has plural tags (papers, paper, author, title), and a unique ID is allocated to each tag.

In the example of FIG. 7, tag ID(1) is allocated to the tag “papers”, tag ID(2) is allocated to the tag “paper”, tag ID (3) is allocated to the tag “author”, and ID(4) is allocated to the tag “title”.

In the XML data (tree expression) shown in FIG. 6, the axis extending from paper to author and the axis extending from paper to title are overlapped with each other, and thus the pathtrie 132 merges the overlapped axes into one axis.

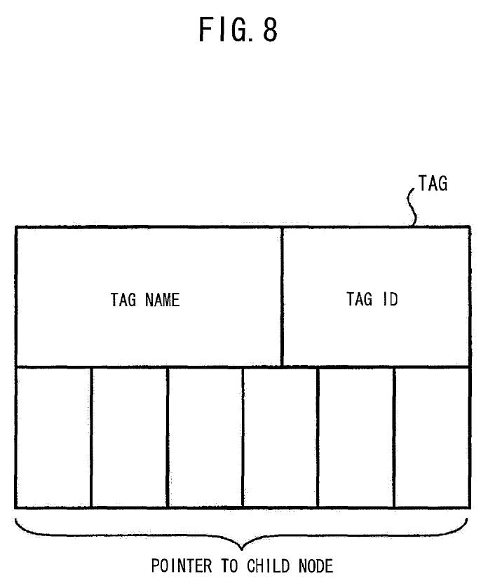

FIG. 8 is a diagram showing an example of the data structure of each tag shown in FIG. 7. As shown in FIG. 8, this tag has a tag name, a tag ID and a pointer to a child node. Here, the tag of “papers” shown in FIG. 7 will be representatively described. “papers” is registered in the tag name, the tag ID(1) is registered in the tag ID and a pointer of “paper” corresponding to a child node is registered in the child node.

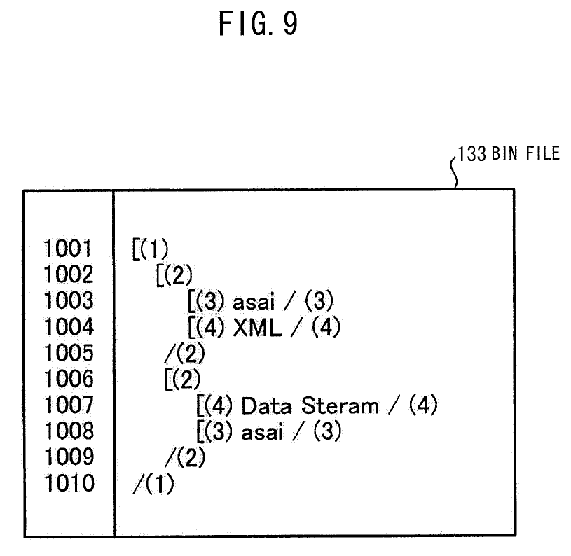

The BIN file 133 is data in which the respective elements contained in the XML data 131 (see FIG. 5) are replaced by IDs of the respective tags of the pathtrie 132 (see FIG. 7). FIG. 9 is a diagram showing an example of the data structure of the BIN file 133. As shown in FIG. 9, this BIN file comprises identification numbers 1001 to 1010 for identifying the positions of the respective elements, and the elements replaced by the tag IDs.

Specifically, comparing FIGS. 5 and 9, <papers> is transformed to [(1), <paper> is transformed to [(2), <author> is transformed to [(3), and <title> is transformed to [(4). Furthermore, </papers> is transformed to /(1), </paper> is transformed to /(2), </author> is transformed to /(3), and </title> is transformed to /(4).

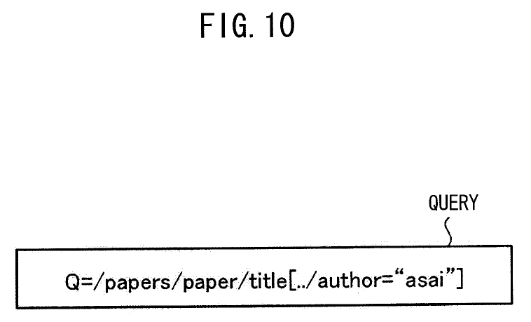

The query data 134 is data in which a query input from the input unit 110 is stored. FIG. 10 is a diagram showing an example of the query stored as the query data 134. The query shown in FIG. 10 has the same meaning as the query described with reference to FIG. 2, and thus the description thereof is omitted.

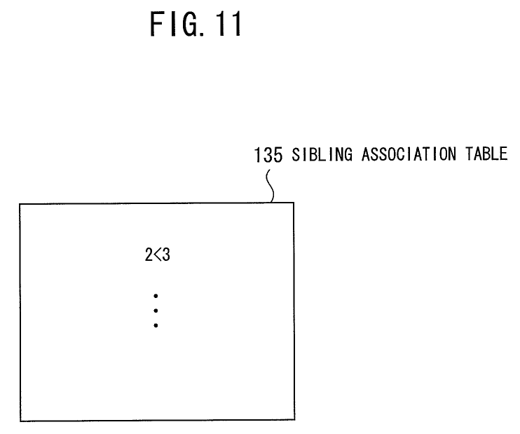

The sibling association table 135 is a table for storing the brother relationship of the respective elements after the axis transformation when the axis transformation is conducted on the query. FIG. 11 is a diagram showing an example of the data structure of the sibling association table 135. As shown in FIG. 11, the brother relationship of the respective elements is shown in the sibling association table 135. For example, in FIG. 11, “2<3” is recorded, and thus it is shown that the element of the number 2 out of the respective elements identified by the numbers 2 and 3 corresponds to an elder brother and the element of the number 3 corresponds to a younger brother.

The automaton data 136 is data in which an automaton created on the basis of the axis-transformed query is stored. The details of the automaton data 136 will be described later.

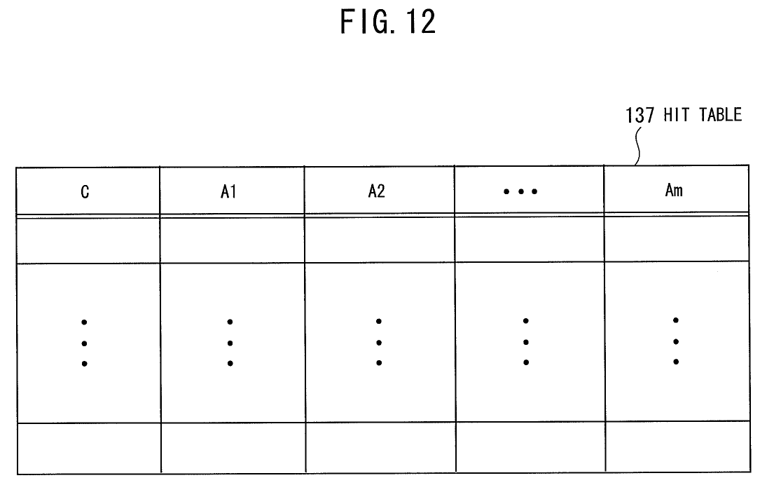

The hit table 137 is a table used when a search target is searched by using the BIN file 133 and the automaton data 136. FIG. 12 is a diagram showing an example of the data structure of the hit table 137. As shown in FIG. 12, the hit table 137 has plural fields for storing the position of the BIN file 133 at which a context node detection event C occurs and the position of the BIN file 133 at which a predicate accept event (Am) derives. The description on the context node detection event and the predicate accept event will be described later.

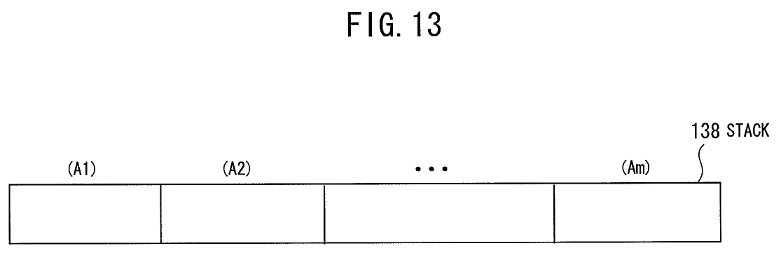

The stack 138 is data in which data to be stored in the hit table 137 is temporarily stored. FIG. 13 is a diagram showing an example of the data structure of the stack. As shown in FIG. 13, the stack 138 has one field for storing the position of the BIN file 133 at which the context node detection event C occurs and the position of the BIN file 133 at which the predicate accept event (Am) derives.

Returning to FIG. 4, the pre-processor 140 is a unit for generating the pathtrie 132 and the BIN file 133 on the basis of the XML data 131, and has a pathtrie creator 141 and a BIN file creator 142. When XML data is obtained from the input unit 110, the pre-processor 140 stores the obtained XML data into the storage unit 130.

The pathtrie creator 141 is a unit for creating a pathtrie 132 (see FIG. 7) on the basis of the XML data 131 (see FIG. 5). Specifically, the pathtrie creator 141 analyzes the XML data 131 to detect duplicated paths of the XML data 131. When there exist duplicated paths in the XML data 131, tags corresponding to the respective elements of the XML data 131 are created under the state that one path out of the duplicated paths is left. Furthermore, according to the parent-child relationship of the XML data 131, the pathtrie creator 141 creates the pathtrie 132 (see FIG. 7) in which the respective tags are connected to one another. In addition, the pathtrie creator 141 allocates a unique tag ID to each tag.

The BIN file creator 142 is a unit for creating the BIN file 133 (see FIG. 9) on the basis of the XML data 131 (see FIG. 5) and the pathtrie 132 (see FIG. 7). Specifically, the BIN file creator 133 compares the respective elements of the XML data 131 with the tag names of the pathtrie 132, and allocates tag IDs of the tag names corresponding to the names of the respective elements of the XML data 131 to create the BIN file 133.

The post-processor 150 is a unit for executing collation processing to detect the data corresponding to the query data 134, and it is equipped with an axis-transforming processor 151, an automaton creator 152 and a collation processor 153. When obtaining query data from the input unit 110, the post-processor 150 stores the query data as query data 134 into the storage unit 130. Furthermore, the post-processor 150 outputs the detected data to the output unit 120.

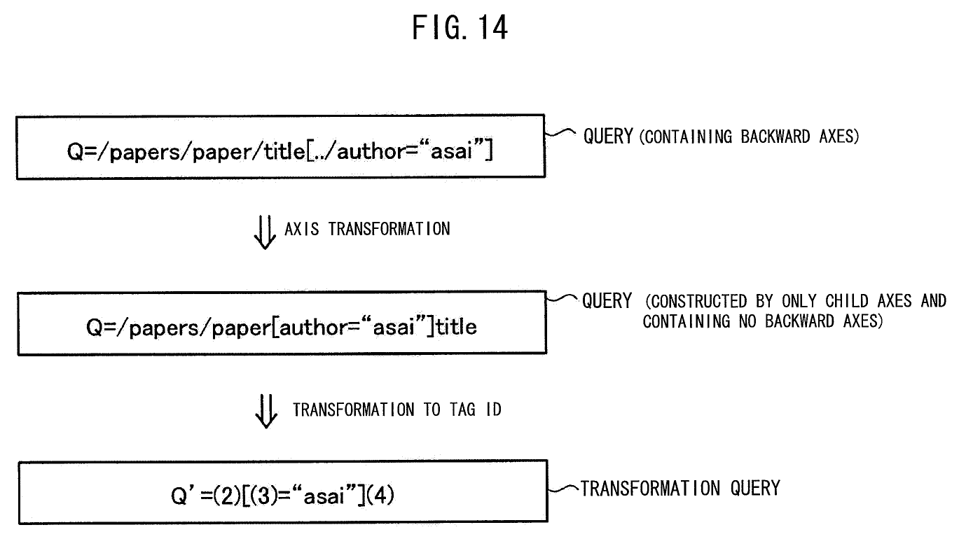

The axis-transforming processor 151 is a unit for executing axis-transformation on the query data 134. FIG. 14 is a diagram showing the summary of the processing of the axis-transforming processor 151. As shown in FIG. 14, the axis-transforming processor 151 executes the axis-transformation on the query (containing the backward axis), and creates a query constructed by only child axes. The axis-transforming processor 151 compares the respective element names of the query with the tag names of the pathtrie 132, whereby the respective elements are transformed by the tag IDs of the tag names corresponding to the respective elements.

In the following description, the processing of the axis-transforming processor 151 will be specifically described. In the axis transformation, the axis-transforming processor 151 executes a sibling (brother) axis transforming processing on the query data 134, and then executes a parent axis transforming processing. In this case, the sibling axis transformation executed by the axis transforming processor 151 will be first described.

(Sibling Axis Transforming Processing)

In the sibling axis transforming processing, the axis transforming processor 151 detects sibling axes from the query data 134. For example, the sibling axes are represented by “following-sibling”, “preceding-sibling” on the query. When detecting the sibling axes, the axis transforming processor 151 transforms the sibling axes to a parent axis and child axes by the sibling axis transforming rule, and registers the sibling (brother) relationship into the sibling association table 135.

The sibling axis transforming rule is “/a/following-sibling::b [symbol] /a/../b” “/a/preceeding-sibling::b [symbol] /a/../b”.

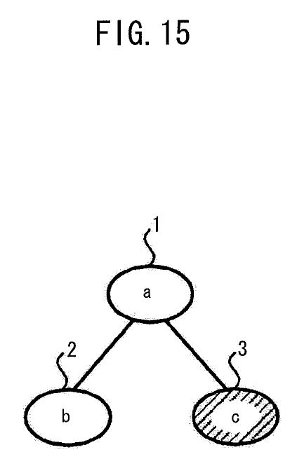

FIG. 15 is a diagram showing a supplementary description of the sibling axis transforming processing. In FIG. 15, it is apparent that the query for searching the node “C” of the XML data is “/a/b/following-sibling::c” and contains the sibling axis “following-sibling”. By applying the sibling axis transforming rule to this query “/a/b/following-sibling::c”, it can be transformed to “/a/b/../c”, and the sibling axis can be represented by only the parent and child axes.

Furthermore, when the sibling axis is transformed to the parent and child axes, the axis transforming processor 151 registers the sibling relationship into the sibling association table 135. In the example of FIG. 15, b identified by the number 2 is an elder brother, and c identified by the number 3 is a younger brother, so that the information to be registered in the sibling association table 135 is “2<3”.

After transforming the sibling axis to the parent axis and the child axes, the axis transforming processor 151 applies the equivalence rule to the transformed query to delete the nest of the predicate portion. The predicate portion is a [ ] portion of the query. What a [ ] further exists in the [ ] is called a nest. Furthermore, with respect to sequential predicate portions, the equivalence rule is applied so that the predicate portion containing the parent axis is located at the head, thereby rearranging the query. For example, by applying the equivalence rule to “π[a] [../b] [c/d]”, it is rearranged to “π[../b][a][c/d]”.

The equivalence rule includes equivalence rules 1 to 7 as described below. The following π1, π2 are path expressions of any query. When S[π1](x)=S[π2](x) is satisfied for any child node xεN, π1 and π2 are equivalent to each other, and this is expressed as “π1≡π2”.

Equivalence rule 1: π1/π≡π2/π (applied only in the case of π1≡π2)

Equivalence rule 2: π/π1≡π/π2 (applied only in the case of π1≡π2)

Equivalence rule 3: π[π1]≡[π2] (applied only in the case of π1≡π2)

Equivalence rule 4: π1[π]≡π2[π] (applied only in the case of π1≡π2)

Equivalence rule 5: π[π1][π2]≡π[π1/π2]

Equivalence rule 6: π[[π1]π2]≡π[π1][π2]

Equivalence rule 7: π[π1][π2]≡π[π2][π1]

(Parent Axis Transforming Processing)

In the parent axis transforming processing, the axis transforming processor 151 detects a query data parent axis. Furthermore, the axis transforming processor 151 applies the parent axis transforming rule to transform the detected parent axis to child axes. For example, a method disclosed in reference document 1 (D. Olteanu et al., “XPath: Looking Forward”, Proc. XMLDM'02, 2002.) may be used as the method of converting the parent axis to the child axes. The parent axis transforming rule contains a parent axis transforming rule 1: π/a/../≡π[a] parent axis transforming rule 2: a/../≡./[π]/a.

The axis transforming processor 151 applies the equivalence rule on the transformed query after the parent axis is converted to the child axes, and deletes the nest of the predicate portion. Furthermore, with respect to the sequential predicate portions, the equivalence rule is applied so that the predicate portion containing the parent axis is located at the head, thereby rearranging the query. The equivalence rule is the same as the equivalence rules 1 to 7, and thus the description thereof is omitted.

Here, a specific example of the process of transforming a path of a query containing a parent axis by applying the parent axis transforming rule and the equivalence rule will be described. The path of the query to be transformed is assumed to be “π=/b1/b2[b3/b4/../../../b8]. This path π contains three parent axes “../” to be transformed.

The result obtained by applying the parent axis transforming rule 1 to the leftmost parent axis of π is represented by π1, π1=/b1/b2[b3[b4]../../b8. The result obtained by applying the parent axis transforming rule 1 to the leftmost parent axis of π1 is represented by π2, π2=/b1/b2/[b3[b4]]../b8].

Subsequently, when the equivalence rule 5 is applied to π2, π2=/b1/b2[b3/b4]../b8], and when the equivalence rule 6 is applied to π2 to which the equivalence rule 5 has been applied, π2=/b1/b2[b3/b4][../b8].

Furthermore, when the equivalence rule 7 is applied to π2 to which the equivalence rule 6 has been applied, π2=/b1/b2[../b8][b3/b4]. The result obtained by applying the parent transforming rule 2 to π2 to which the equivalence rules 5 to 7 have been applied is represented by π3, π2=/b1[b8]b2[b3/b4]

When the axis transforming processor 151 executes the parent axis (or ancestor axis) transforming processing on the query, the parent axis is transformed after the descendant axis is developed by pathtrie. For example, when the parent axis transforming processing is executed on π=/a//../d, the parent axis transforming processing is executed after π is developed to /a/b/../d, a/b/c/d../d, and then converted to /a[b]d, a/b/c[b]d.

The axis transforming processor 151 executes the sibling axis transforming processing and the parent axis transforming processing on the query stored in the query data 134, and registers the axis-transformed query into the query data 134. That is, the query before the axis transformation is renewed by the axis-transformed query. Furthermore, the axis transforming processor 151 compares the element names of the transformed query with the tag names of the pathtrie 132 to transform each element name of the query to a tag ID. The query converted to the tag ID is represented as a transformed query.

Returning to FIG. 4, the automaton creator 152 is a unit for creating automaton data corresponding to the transformed query created by the axis transforming processor 151. The automaton data created by the automaton creator 152 are stored as automaton data 136 in the storage unit 130.

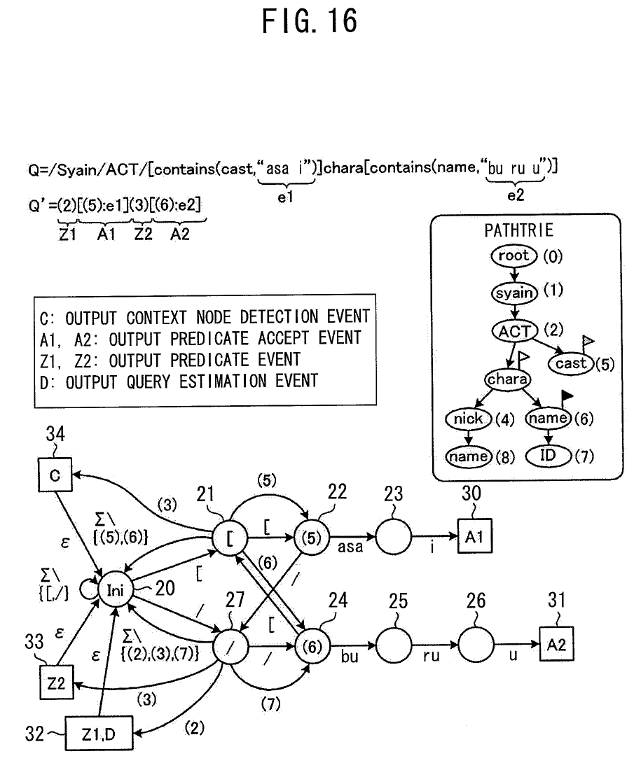

Here, the processing of the automaton creator 152 will be described in detail. FIG. 16 is a diagram to supplementarily describe the processing of the automaton creator 152. In this case, for the sake of convenience of description, creation of the automaton will be described while the query is set to Q=/Syain/ACT/[contains(cast, “asa i”)]chara[contains(name, “bu ru u”))], and the transformed query in which the respective elements of the query are transformed to tag IDs is set to Q′=(2) [(5):e1](3)[(6):e2]. In the transformed query Q′, “(2)” corresponds to “/Syain/ACT”, “(3)” corresponds to “chara”, “[(5):e1]” corresponds to “[contains(cast, “asa i”)]”, and “[(6):e2] ” corresponds to “[contains (name, “bu ru u”))] ”. The automaton corresponding to the transformed query Q′ is an automaton shown at the lower stage of FIG. 16.

The automaton shown in FIG. 16 is equipped with plural node structures 20 to 27, and event structures 30 to 34. Furthermore, with respect to lines for connecting the node structures 20 to 26 and the event structures 30 and 31, when the conditions corresponding to the lines are satisfied, the processing is shifted in the directions indicated by the arrows. In FIG. 16, ε represents that the processing shifts in the directions of the arrows without condition, and Σ¥{n} indicates that the processing shifts in the directions of the arrows in the case of values other than n.

First, the automaton creator 152 analyzes the transformed query Q′ to extract:

set of predicate path IDs: A={a1, . . . , an} (n represents natural number)

set of branch path IDs: A={z1, . . . , zn} (n represents natural number)

context path ID: c

estimation path ID: d

keyword set key(ai) to each aiεA

In the transformed query Q′ shown in FIG. 16, the automaton creator 152 extracts “(5), (6)” as a set of predicate path IDs, and extracts “(2), (3)” as a set of branch path IDs. Furthermore, the automaton creator 152 extracts “(3)” as a context path ID. With respect to a method of extracting the context path ID, the corresponding ID prior to the last predicate portion [ ]of the transformed query Q′ is extracted.

Furthermore, the automaton creator 152 extracts “(2)” as an estimation path ID. For example, the left most ID of the transformed query Q′ is extracted as the estimation path ID. “e1(asa i)”, “e2 (bu ru u)” are extracted as the keyword set key(ai).

Subsequently, the automaton creator 152 creates:

initial state Ini of automaton (node structure 20 of FIG. 16)

start state Open (state under which start symbol “[” is read: node structure 21)

end state Close (end symbol “/”; node structure 27)

Here, Goto(Ini,“[”)=Open and Goto(Ini,“/”)=Close

The automaton creator 152 executes the following processing 1-1 to 1-6 on any i=1 to n. First, in the processing 1-1, the automaton creator 152 creates the state State(ai) corresponding to the predicate path ID (aiEA). In the example of FIG. 16, the node structure 22 of State(a1) corresponding to (5) and the node structure 24 of State(a2) corresponding to (6) are generated.

In the processing 1-2, the automaton creator 152 creates a keyword reference automaton accepting key (ai), and links from the node structure of each state State (ai). In the example shown in FIG. 16, the respective node structures 22, 23 and the event structure 30 in the path extending from the node structure 22 of State(a1) till the event structure 30“A1” are linked to one another. Furthermore, the node structures 24, 25, 26 and the event structures 31 in the path extending from the node structure 24 of State(a2) till the event structure 31 “A2” are linked to one another.

Subsequently, in the processing 1-3, the automaton creator 152 connects the node structure 22 of State (a1) and the node structure 21 and connects the node structure 24 of State(a2) and the node structure 21 so that Goto(Open, ai)=State(ai) for each state State(ai).

In the processing 1-4, the automaton creator 152 connects the node structure 24 of State(a2) and the node structure 27 so that Goto(Close, b)=State(ai) for any child of ai on the pathtrie. In the example of FIG. 16, the child of the tag (name) corresponding to the tag ID(6) is the tag (ID) corresponding to the tag ID(7).

In the processing 1-5, the automaton creator 152 creates the state State(zi) corresponding to the branch path ID(ziE). In the example shown in FIG. 16, the event structure 32 (Z1) of State(z1) corresponding to (2) and the event structure 33 “Z2” of State(z2) corresponding to (3) are created.

In the processing 1-6, the automaton creator 152 connects the event structure 32 of State(z1) and the node structure 27 and connects the event structure 33 of State(z2) and the node structure 27 so that Goto(close,zi)=State(zi) for each state State(z1)

Subsequently, the automaton creator 152 creates the state State(c) corresponding to the context path ID“c”. In the example shown in FIG. 16, the event structure 34 “C” is created. The node structure 21 and the event structure 34 are connected to each other so as to satisfy Goto(open, c)=State(c).

The automaton creator 152 creates the state State(d) corresponding to the estimation path ID“d”. In the example shown in FIG. 16, the event structure 32“D” is created. In FIG. 16, “Z1” and “D” are assembled into one event structure 32. The node structure 33 and the event structure 27 are connected to each other so as to satisfy Goto(close, d)=State(d).

The automaton creator 152 executes the various kinds of processing as described above, creates the automaton data corresponding to the transformed query Q′ and stores the created automaton data into the storage unit 130.

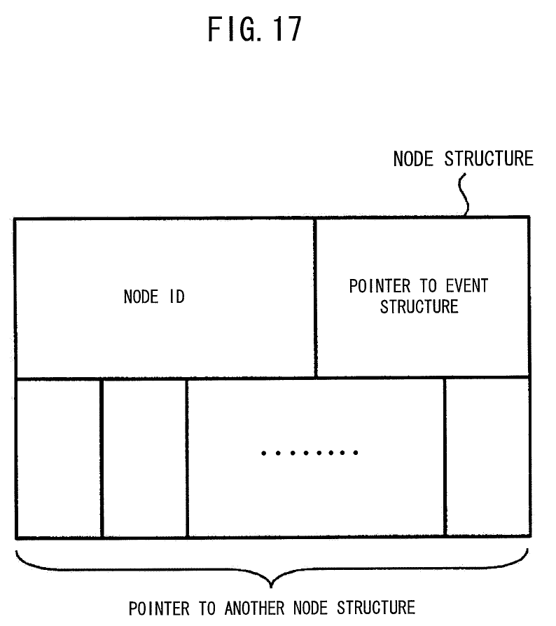

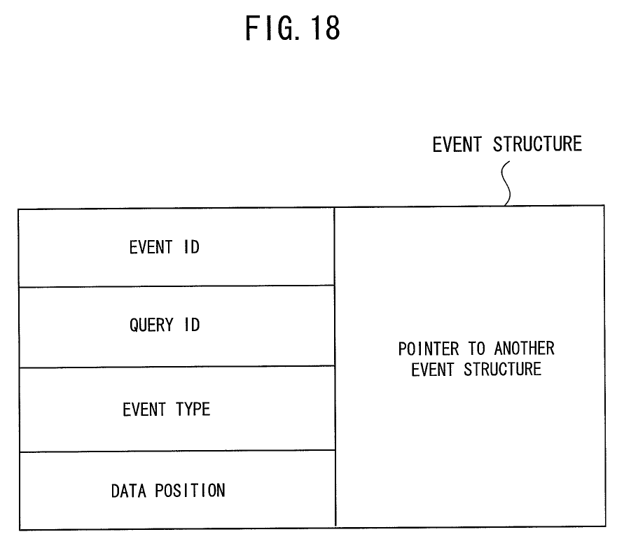

Here, the data structure of the node structure contained in the above automaton data and the data structure of the event structure will be described. FIG. 17 is a diagram showing an example of the data structure of the node structure, and FIG. 18 is a diagram showing an example of the data structure of the event structure.

As shown in FIG. 17, the node structure is equipped with node ID for identifying the node structure, a pointer to the event structure and pointers to other node structures. For example, when the node structure 21 shown in FIG. 16 is cited, the pointer corresponding to the event structure 34 is stored in the pointer to the event structure. Furthermore, the pointers corresponding to the nodes 20, 22, 24 are stored in the pointer to the node structure.

Furthermore, as shown in FIG. 18, the event structure is equipped with event ID for identifying the event structure, query ID for identifying the query, an event type for identifying the event type, a data position of the event structure, and pointers to other event structures. The event type includes a context node detection event, a predicate accept event, a predicate estimation event and a query estimation event.

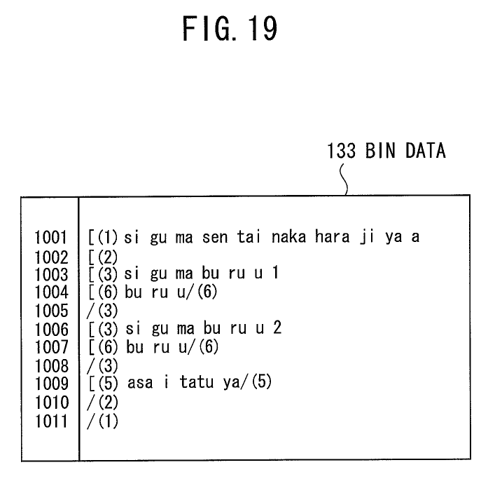

Returning to the description of FIG. 4, the collation processor 153 is a unit for outputting the data corresponding to the query data 134 on the basis of the BIN file 133 and the automaton data 136. Here, the processing of the collation processor 153 will be specifically described. For convenience of description, the description will be made by using the BIN file shown in FIG. 19 and the automaton data shown in FIG. 16. FIG. 19 is a diagram showing an example of the data structure of the BIN file for describing the collation processing.

An event E occurring in the process of executing the processing by the collation processor 153 while the BIN file is subjected to automaton data substitution to execute the processing is defined as E=(Q,T,P). Here, “Q” contained in the event E represents the query ID, “T” represents the event type, and “P” represents the data position at the instantaneous time when the event occurs.

When “T” of the event E is a context node detection event (C), the collation processor 153 registers a new entry into the hit table 137 of the query ID “Q” (see FIG. 12), and registers the content of the present stack 138 (see FIG. 13) into the content of the registered new entry.

When “T” of the event E is the predicate accept event (Am), the collation-processor 153 registers “P” contained in the event E into the hit table 137 of the query ID “Q” and the m-th item of the stack 138.

When “T” of the event E is the predicate estimation event (Zm), the collation processor 153 deletes an entry in which the m-th item is empty in the hit table 137 of the query ID “Q”, and deletes the m-th item of the stack 138.

When “T” of the event E is the query estimation event (D), the collation processor 153 outputs the entry surviving in the hit table of the query ID “Q” as a resolution to the output unit 120.

In consideration of the foregoing matter, it will be described the processing of the collation processor 153 using the automaton shown in FIG. 16 and the BIN file shown in FIG. 19. The processing of the collation processor 153 is describe by the positions “1001” and “1011” of the BIN file.

(Position “1001” of BIN File)

The collation processor 153 substitutes data “[(1) si gu ma sen tai naka hara ji ya a” corresponding to the position “1001” of the BIN file into the automaton. At this time, the data concerned contains the node structure 20 as a start point, and there exists no next corresponding character at the shift stage to the node structure 21, so that the data returns to the node structure 20 and the search of the position “1001” is finished.

(Position “1002” of BIN File)

The collation processor 153 substitutes the data “[(2)” corresponding to the position “1002” of the BIN file into the automaton. At this time, the data concerned contains the node structure 20 as a start point, and there exists no next corresponding character at the shift stage to the node structure 21, so that the data returns to the node structure 20 and the search of the position “1002” is finished.

(Position “1003” of BIN File)

The collation processor 153 substitutes the data “[(3) si gu ma bu ru u 1” corresponding to the position “1003” of the BIN file into the automaton. At this time, the data concerned contains the node structure 20 as a start point, and reaches the event structure 34. At the time point when the data reaches the event structure 34, the collation processor 153 generates event E1=(Q1, C, 1003).

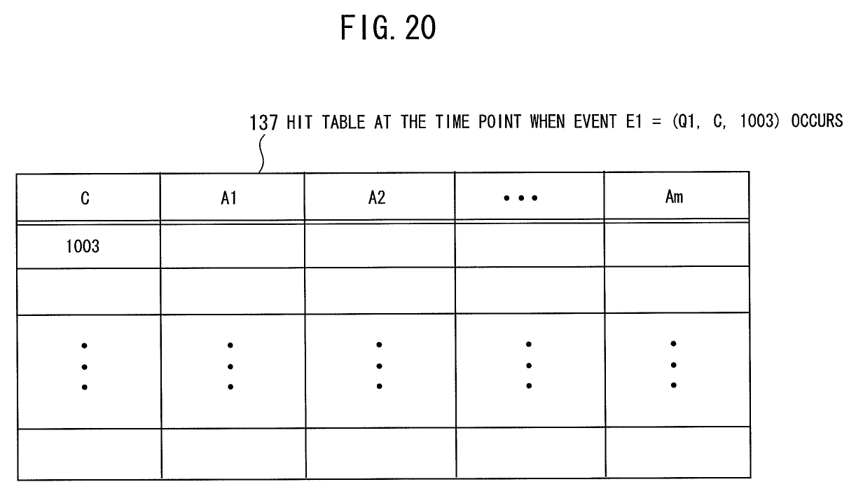

FIG. 20 is a diagram showing the state of the hit table 137 at the time point when the event E1=(Q1, C, 1003) is generated. The values of the stack 138 are copied to A1 to Am corresponding to the line of “1003” of the hit table 137 shown in FIG. 20. At the present stage, nothing is registered in the stack 138, and thus nothing is copied to the hit table 137 at the present stage.

(Position “1004” of BIN File)

The collation processor 153 substitutes the data “[(6) bu ru u /(6)” corresponding to the position “1004” of the BIN file into the automaton. At this time, the data concerned contains the node structure 20 as a start point, and reaches the event structure 31. At the time point when the data reaches the event structure 31, the collation processor 153 generates event E2=(Q1, A2, 1004).

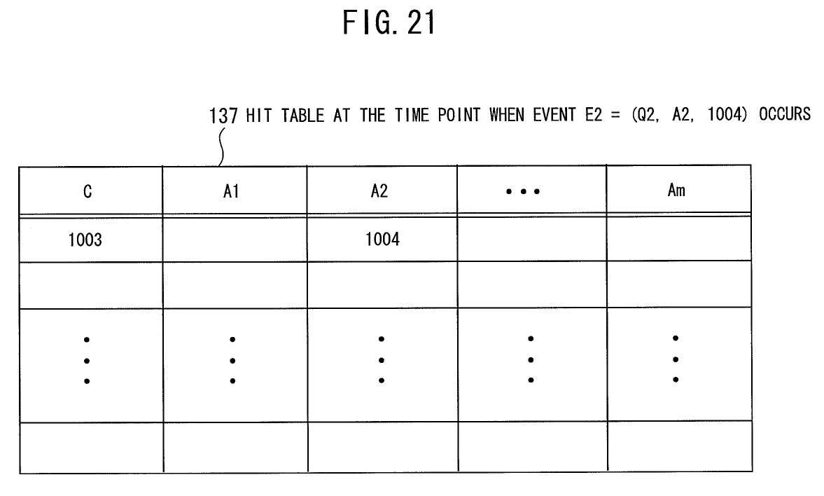

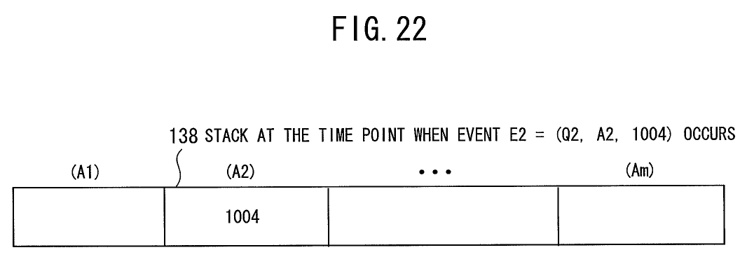

FIG. 21 is a diagram showing the state of the hit table 137 at the time point when event E2=(Q1, A2, 1004) is generated, and FIG. 22 is a diagram showing the state of the stack 138 at the time point when event E2=(Q2, A2, 1004) is generated. As shown in FIGS. 21 and 22, “1004” is registered at the corresponding position of “A2”.

(Position “1005” of BIN File)

The collation processor 153 substitutes the data “/(3)” corresponding to the position “1005” of the BIN file into the automaton. At this time, the data concerned contains the node structure 20 as a start point, and reaches the event structure 32. At the time point when the data reaches the event structure 32, the collation processor 153 generates event E3=(Q1, Z2, 1005).

When event E3=(Q1, Z2, 1005) is generated, the collation processor 153 refers to the hit table 137 to delete a line on which “A2” is not set. At the present stage, a value is set in “A2” in the hit table 137 as shown in FIG. 21, and thus line deletion is not executed. Furthermore, when event E3=(Q1, Z2, 1005) is generated, the collation processor 153 clears “A2” of the stack 138.

(Position “1006” of BIN File)

The collation processor 153 substitutes the data “[(3) si gu ma bu ru u 2” corresponding to the position “1006” of the BIN file into the automaton. At this time, the data concerned contains the node structure 20 as a start point, and reaches the event structure 34. At the time point when the data reaches the event structure 34, the collation processor 153 generates event E4=(Q1, C, 1006).

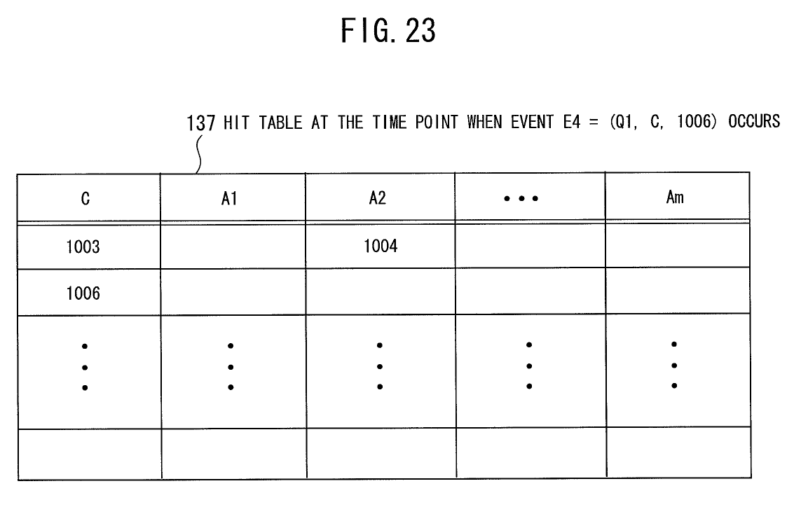

FIG. 23 is a diagram showing the state of the hit table 137 at the time point when event E4=(Q1, C, 1006) is generated. As shown in FIG. 23, “1006” is registered in the column “C” of the hit table 137.

(Position “1007” of BIN File)

The collation processor 153 substitutes the data “[(6) bu ru u /(6)” corresponding to the position “1007” of the BIN file into the automaton. At this time, the data concerned contains the node structure 20 as a start point, and reaches the event structure 31. At the time point when the data reaches the event structure 31, the collation processor 153 generates event E5=(Q1, A2, 1007).

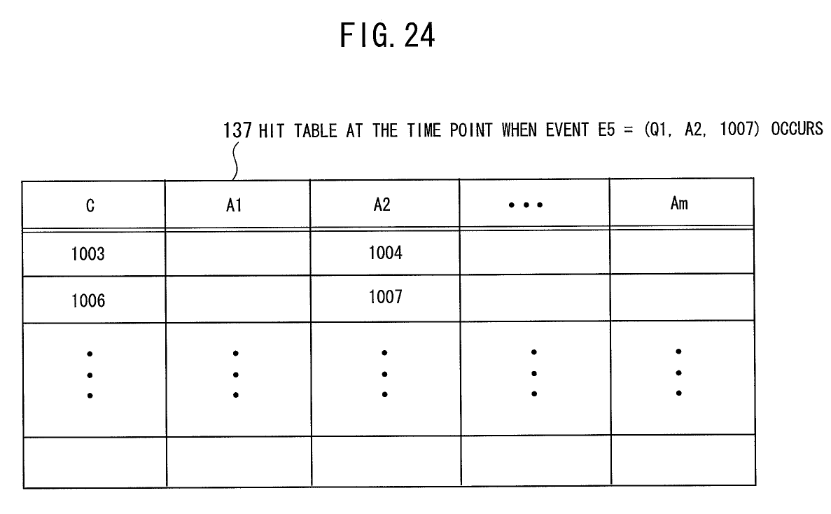

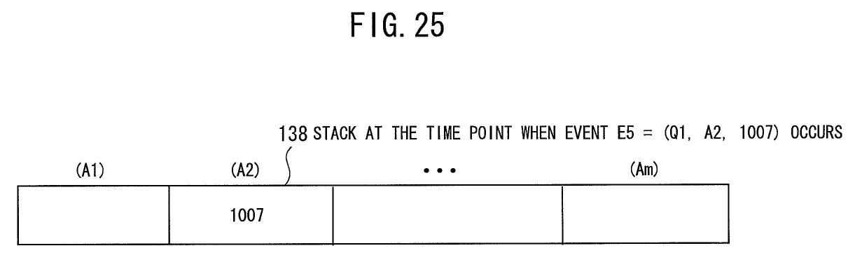

FIG. 24 is a diagram showing the state of the hit table 137 at the time point when event E5=(Q1, A2, 1007) is generated, and FIG. 25 is a diagram showing the state of the stack 138 at the time point when event E5=(Q1, A2, 1007) is generated. As shown in FIGS. 24 and 25, “1007” is registered at the corresponding position of “A2”.

(Position “1008” of BIN File)

The collation processor 153 substitutes the data “/(3)” corresponding to the position “1008” of the BIN file into the automaton. At this time, the data concerned contains the node structure 20 as a start point, and reaches the event structure 33. At the time point when the data reaches the event structure 33, the collation processor 153 generates event E6=(Q1, Z2, 1008).

When event E6=(Q1, Z2, 1008) is generated, the collation processor 153 refers to the hit table 137 and deletes a line on which “A2” is not set. As shown in FIG. 24, a value is set in “A2” in the hit table 137 at the present stage, and thus line deletion is not executed. Furthermore, when event E6=(Q1, Z2, 1008) is generated, the collation processor 153 clears “A2” of the stack 138.

(Position “1009” of BIN File)

The collation processor 153 substitutes the data “[(5) asa i tatu ya /(5)” corresponding to the position “1009” of the BIN file into the automaton. At this time, the data concerned contains the node structure 20 as a start point, and the data reaches the event structure 30. At the time point when the data reaches the event structure 30, the collation processor 153 generates event E7=(Q1, A1, 1009).

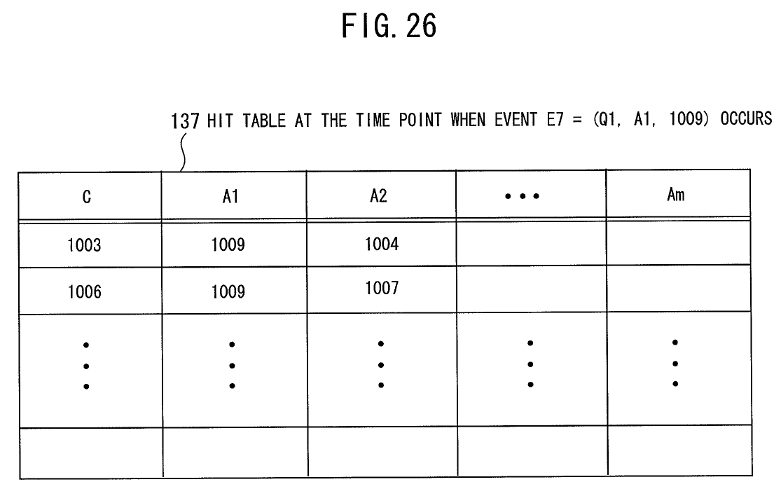

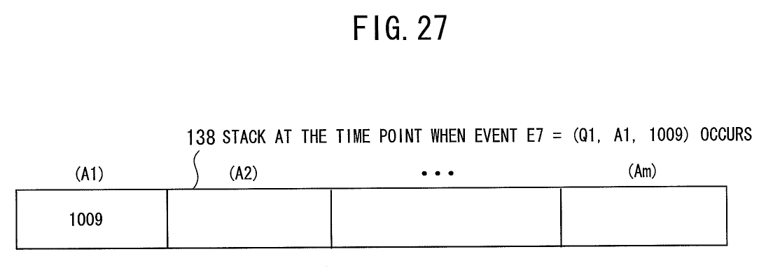

FIG. 26 is a diagram showing the state of the hit table 137 at the time point when event E7=(Q1, A1, 1009) is generated, and FIG. 27 is a diagram showing the state of the stack 138 at the time point when event E7=(Q1, A1, 1009) is generated. As shown in FIGS. 26 and 27, “1009” is registered at the corresponding position of “A1”.

(Position “1010” of BIN File)

The collation processor 153 substitutes the data “/(2)” corresponding to the position “1010” of the BIN file into the automaton. At this time, the data concerned contains the node structure 20 as a start point, and reaches the event structure 32. At the time point when the data reaches the event structure 32, the collation processor 153 generates event E8=(Q1, Z1, 1010), E9=(Q1, D, 1010).

When event E8=(Q1, Z1, 1010) is generated, the collation processor 153 refers to the hit table 137 to delete a line on which “A1” is not set. As shown in FIG. 26, a value is set in “A1” in the hit table 137 at the present stage, and thus line deletion is not executed. When event E8=(Q1, Z1, 1010) is generated, the collation processor 153 clears “A1” of the stack 138.

When event E9=(Q1, D, 1010) is generated, the collation processor 153 refers to the hit table 137 and outputs the position information registered in the column “C” of the hit table 137 to the output unit 120. In the example shown in FIG. 26, the positions “1003”, “1006” of the BIN file are output. The position data concerned corresponds to the query data 134. When event E9=(Q1, D, 1010) is generated, the collation processor 153 deletes the data registered in the hit table 137.

(Position “1011” of BIN File)

The collation processor 153 substitutes the data “/(1)” corresponding to the position “1011” of the BIN file into the automaton. At this time, the data concerned contains the node structure 20 as a start point, and no next corresponding character exists at the shift stage to the node structure 27, so that the data returns to the node structure 20 and the search of the position “1011” is finished.

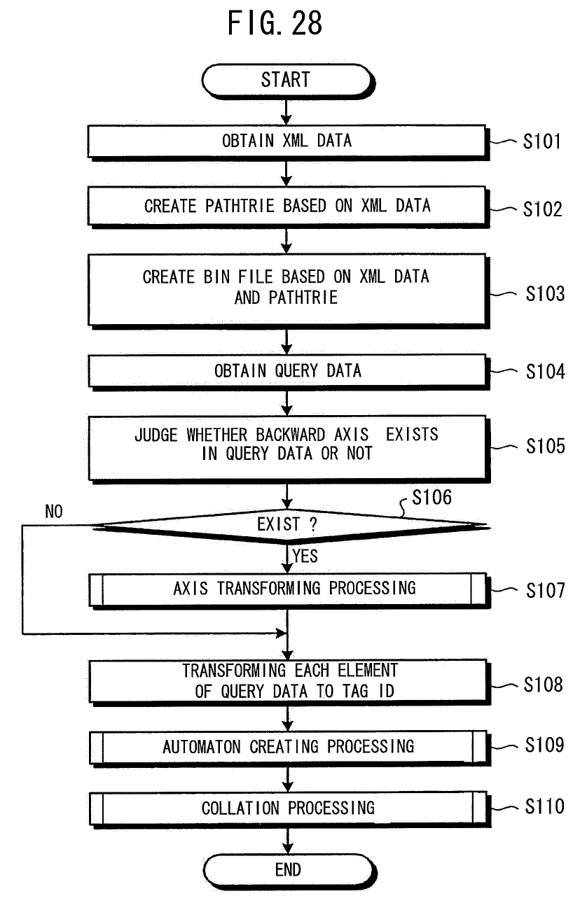

Next, the processing of the collation processing device 100 according to this embodiment will be described. FIG. 28 is a flowchart showing the processing flow of the collation processing device 100 according to this embodiment. As shown in FIG. 28, the collation processing device 100 obtains XML data 131 (step S101). The pathtrie creator 141 creates the pathtrie 132 on the basis of the XML data 131 (step S102). The BIN file creator 142 creates the BIN file on the basis of the XML data 131 and the pathtrie 132 (step S103).

The collation processing device 100 obtains the query data 134 (step S104), and judges whether a backward axis exists in the query data 134 (or the axis transformation is necessary) or not (step S105).

When no backward axis exists in the query data 134 (or the axis transformation is unnecessary) (step S106, No), the processing shifts to step S108. The step S108 will be described later.

On the other hand, when a backward axis exists in the query data 134 (or the axis transformation is necessary) (step S106, Yes), the axis transforming processor 151 executes the axis transforming processing of the query data 134 (step S107). Then, the axis transforming processor 151 transforms each element of the query data 134 to tag ID (path ID) (step S108).

The automaton creator 152 creates the automaton data 136 on the basis of the query data 134 (step S109). The collation processor 153 executes the collation processing on the basis of the automaton data 136 and the BIN file 133 (step S110).

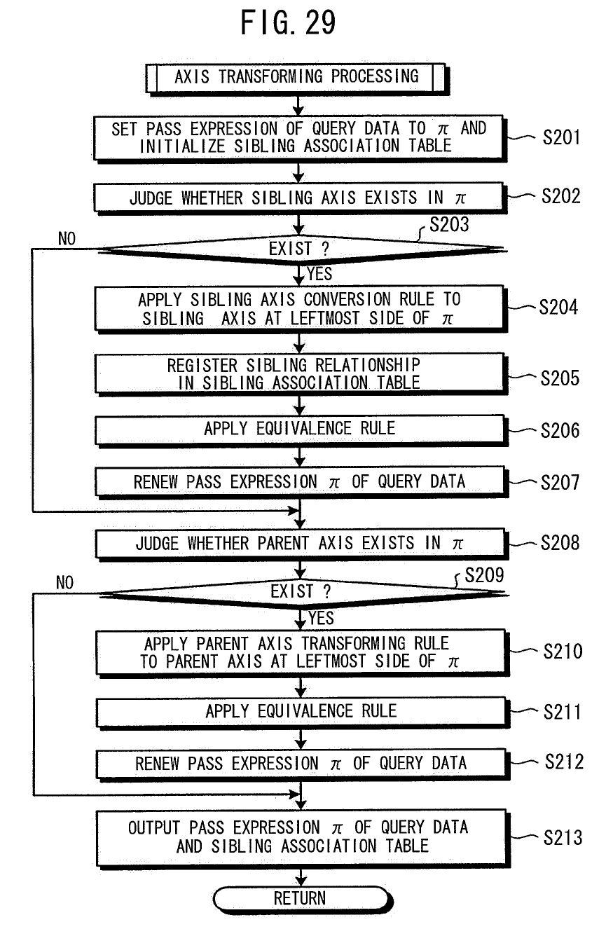

The axis transforming processing shown in step S107 of FIG. 28 will be described. FIG. 29 is a flowchart showing the axis transforming processing according to this embodiment. As shown in FIG. 29, the axis transforming processor 151 sets the path expression of the query data as π, initializes the sibling association table 135 (step S201), and judges whether a sibling axis exists in π (step S202).

If no sibling axis exists in π (step S203, No), the processing shifts to step S208. The description on the step S208 will be described later. On the other hand, if some sibling axis exists in π (step S203, Yes), the sibling axis transforming rule is applied to the leftmost sibling axis of π (step S204) to register the sibling relationship into the sibling association table 135 (step S205).

When the equivalence rule is applied, the axis transforming processor 151 applies the equivalence rule to π (step S206) to renew the path expression π of the query data 134 (step S207).

Subsequently, the axis transforming processor 151 judges whether any parent axis exists in π (step S208). If no parent axis exists in π (step S209, No), the processing shifts to step S213. The step S213 will be described later.

On the other hand, if some parent axis exists in π (step S209, Yes), the axis transforming processor 151 applies the master parent transforming rule to the leftmost parent axis of π (step S210). If the equivalence rule is applied, the axis transforming processor 151 applies the equivalence rule to π (step S211). The axis transforming processor 151 renews the path expression π of the query data 134 (step S212), and outputs the path expression π of the query data 134 and the sibling association table 135 (step S213).

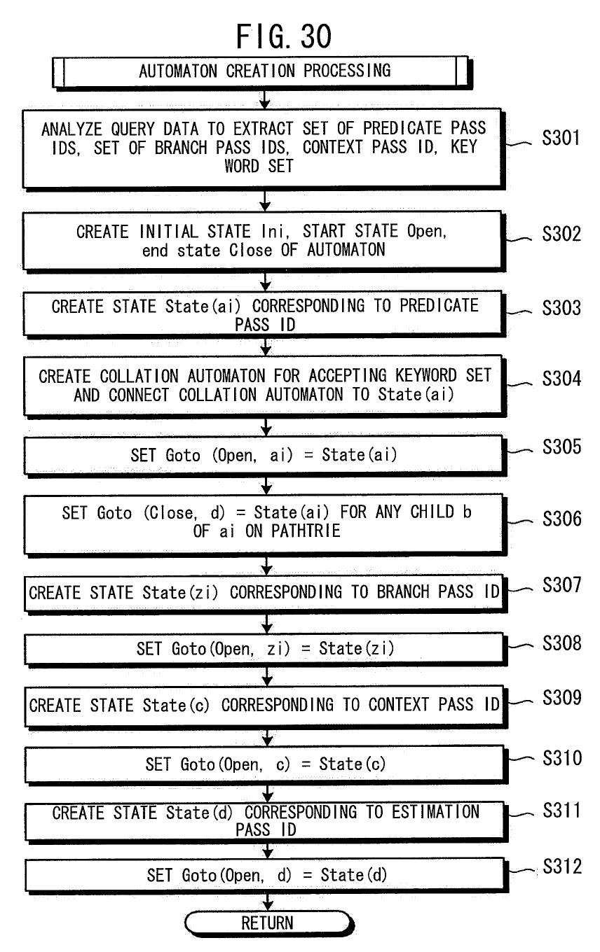

Next, the automaton creation processing shown in step S109 of FIG. 28 will be described. FIG. 30 is a flowchart showing the automaton creation processing according to this embodiment. As shown in FIG. 28, the automaton creator 152 analyzes the query data 134 to extract the set of predicate path IDs, the set of branch path IDs, the context path Id and the keyword set (step S301).

The automaton creator 152 creates the initial state Ini, the start state Open, the end state Close of the automaton (step S302), and creates the state State(ai) corresponding to the predicate path ID (step S303). The automaton creator 152 creates a collation automaton for accepting the keyword set and connects it to the State(ai) (step S304).

Subsequently, the automaton creator 152 sets Goto (Open, ai)=State(ai) (step S305), and sets Goto(Close, d)=State(ai) for any child b of ai on the pathtrie (step S306). The automaton creator 152 creates the state State(zi) corresponding to the branch path ID (step S307), and sets Goto(Open,zi)=State(zi) (step S308).

The automaton creator 152 creates the state State(c) corresponding to the context path ID (step S309), and sets Goto(Open, c)=State(c) (step S310). The automaton creator 152 creates the state State(d) corresponding to the estimation path ID (step S311), and sets Goto(Open, d)=State(d) (step S312).

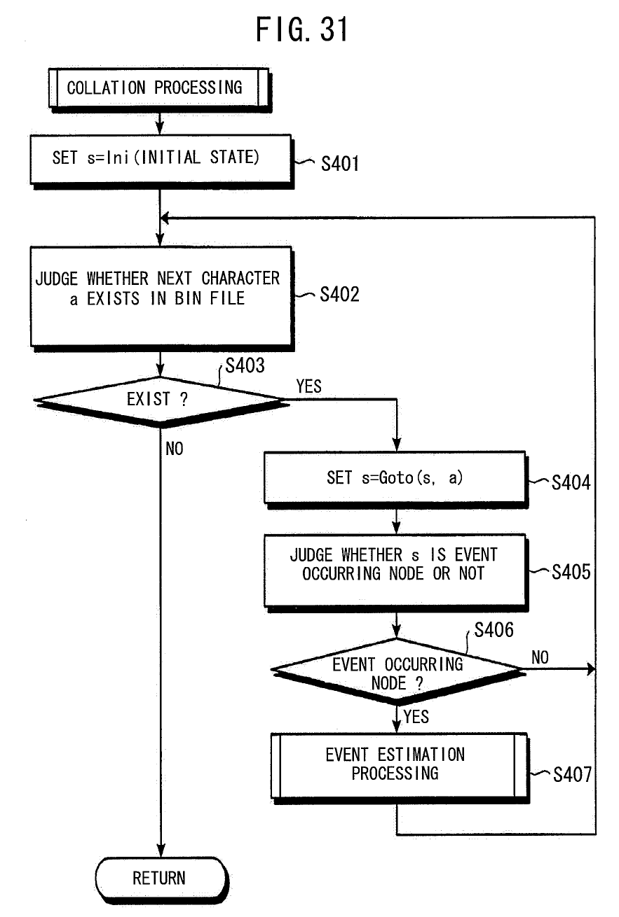

Next, the collation processing shown in step S110 of FIG. 28 will be described. FIG. 31 is a flowchart showing the collation processing according to this embodiment. As shown in FIG. 31, the collation processor 153 sets s=Ini (initial state) (step S401). The collation processor 153 judges whether a next character “a” exists in the BIN file 133 (step S402), and if the next character “a” does not exist (step S403, No), the collation processing is finished.

On the other hand, if the next character “a” exists in the BIN file 133 (step S403, Yes), the collation processor 153 sets s=Goto(s,a) (step S404), and judges whether “s” is an event-occurring node or not (step S405).

If “s” is not the event occurring node (step S406, No), the collation processor 153 shifts the processing to step S402. On the other hand, if “s” is an event occurring node (step S406, Yes), the collation processor 153 executes the event estimation processing (step S407), and shifts the processing to step S402.

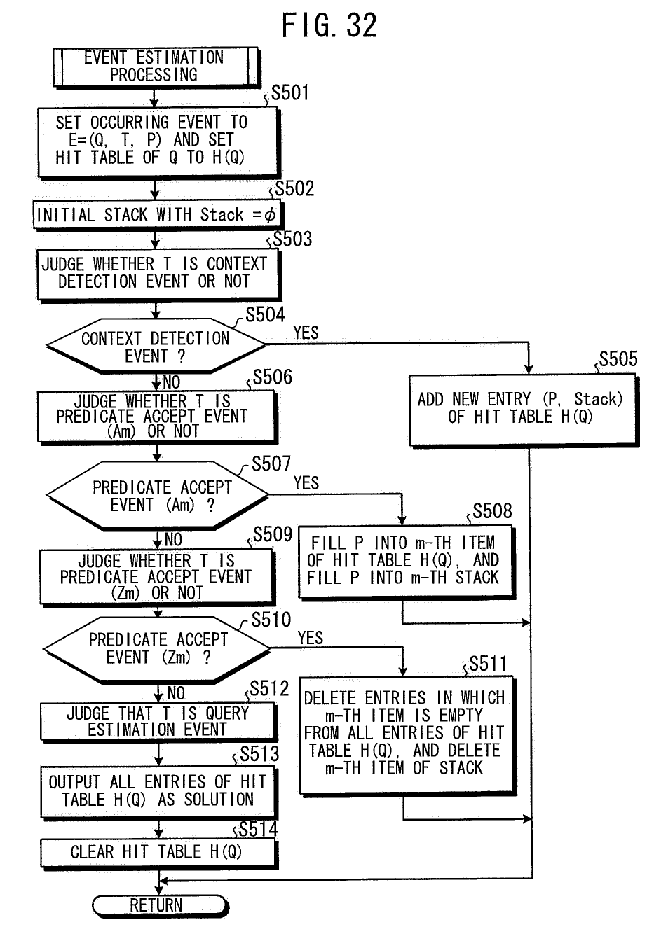

Next, the event estimation processing shown in step S407 of FIG. 31 will be described. FIG. 32 is a flowchart showing the event estimation processing according to this embodiment. As shown in FIG. 32, the collation processor 153 sets the occurring event to E=(Q, T, P), sets the hit table 137 of Q to H(Q) (step S501), and initializes the stack 138 to Stack=φ (step S502).

Then, the collation processor 153 judges whether T is a context detection event or not (step S503), and if it is the context detection event (step S504, Yes), the collation processor 153 adds a new entry (P, Stack) to the hit table H(Q) (step S505), and then finishes the event estimation processing.

On the other hand, if T is not the context detection event (step S504, No), the collation processor 153 judges whether T is a predicate accept event (Am) (step S506). If the judgment result is the predicate accept event (Am) (step S507, Yes), the collation processor 153 fills P into the m-th item of the hit table H(Q), fills P into the m-th item of the stack (step S508), and then finishes the event estimation processing.

On the other hand, if T is not the predicate accept event (Am) (step S507, No), the collation processor 153 judges whether T is a predicate accept event (Zm) (step S509). If the judgment result is the predicate accept event (Zm) (step S510, Yes), the collation processor 153 deletes entries having empty m-th items from all the entries of the hit table H(Q), deletes the m-th item of the stack 138 (step S511) and then finishes the event estimation processing.

On the other hand, if T is not the predicate accept event (Zm) (step S510, No), the collation processor 153 judges T as a query estimation event (step S512), outputs all the entries of the hit table H(Q) as solutions (step S513), and clears the hit table H(Q) (step S514).

As a result, according to this embodiment, the data corresponding to the query data can be searched from the XML data 131 through stream processing even when backward axes, etc. are contained in the query data. Furthermore, the load imposed on the collation processing device 100 can be reduced. In addition, the hierarchical management of the query data 134 is unnecessary, and thus the data corresponding to the query data 134 can be searched at high speed.

Furthermore, the data corresponding to a search formula can be searched from document data at high speed and efficiently irrespective of the construction of the search formula. Still furthermore, the data corresponding to the search formula can be efficiently searched through stream processing. The data corresponding to the search formula can be efficiently searched. In addition, the data corresponding to a search formula containing branches can be efficiently output.

Out of the respective processing described in this embodiment, all or a part of the processing which is described as being automatically performed may be manually performed. Or, all or a part of the processing which is described as manually performed may be performed automatically by a well-known method. The processing flow, the control flow, the information containing the specific titles, various kinds of data and parameters which are described in this specification and shown in the drawings may be arbitrarily altered unless specifically otherwise described.

Furthermore, the construction of the collation processing device 100 shown in FIG. 4 is functionally conceptual, and it is not required to be physically designed in such a style as illustrated. That is, the specific style of the dispersion and integration of the respective devices is not limited to the illustrated style, and all or some of the devices may be functionally or physically dispersed from or integrated with every or any unit in accordance with various kinds of load or use status. Furthermore, all or some of the respective processing functions executed by the respective devices can be implemented by CPU (or MCU, MPU) and programs which are analyzed and executed by the CPU, or implemented as hardware based on wire logic.

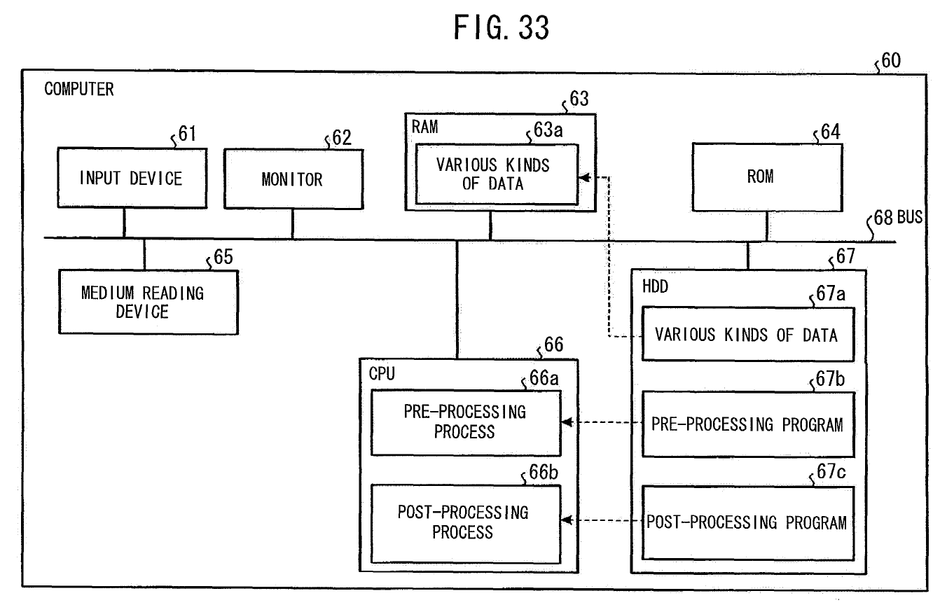

FIG. 33 is a diagram showing the hardware construction of a computer having the collation processing device 100 shown in FIG. 4. This computer 60 is constructed by an input device 61 for accepting an input of data from a user, a monitor 62, RAM (Random Access Memory) 63, ROM (Read Only Memory) 64, a medium reading device 65 for reading data from a storage medium, CPU (Central Processing Unit) 66 and HDD (Hard Disk Drive) 67 which are connected to one another through a bus 68.

A pre-processing program 67b and a post-processing program 67c which can exercise the same functions as the collation processing device 100 described above are stored in HDD 67. CPU 66 reads out the pre-processing program 67b and the post-processing program 67c from HDD 67 and executes these programs, whereby a pre-processing process 66a and a post-processing process 66b which implement the function of the function portion of the collation processing device 100 described above are started. The pre-processing process 66a and the post-processing process 66b correspond to the pre-processor 140 and the post-processor 150 shown in FIG. 4, respectively.

Furthermore, various data 67a corresponding to data stored in the storage unit 130 of the collation processing device 100 described above are stored in HDD 67. The various kinds of data 67a correspond to the XML data 131, the pathtrie 132, the BIN file 133, the query data 134, the sibling association table 135, the automaton data 136, the hit table 137 and the stack 138 shown in FIG. 4.

CPU 66 stores various data 67a into HDD 67. It also reads various data 67a from HDD 67 and stores these data into RAM 63. Furthermore, CPU 66 uses various data 63a stored in RAM 63 to execute the collation processing.

What is claimed is:

1. A computer-readable recording medium storing a collation processing program executed by a computer, the program comprising:
a document storing procedure storing into a storage device document data having a hierarchical structure in which elements are sectioned by element identifiers;
an axis transforming procedure executing axis transformation on a search formula for searching data contained in the document data stored in the storage device when the search formula concerned is obtained so that the search formula concerned is transformed to a search formula constructed of child axes;
an automaton creating procedure identifying the kind of element identifiers contained in the search formula transformed in the axis transforming procedure to create an automaton corresponding to the search formula concerned; and
a collation processing procedure collating in order the data contained in the document data with the automaton and outputting the data corresponding to the search formula concerned.

2. The computer-readable recording medium according to claim 1, wherein the axis transforming procedure judges whether a sibling axis exists in the search formula, and transforms the sibling axis to a parent axis and child axes when the sibling axis exists.

3. The computer-readable recording medium according to claim 1, wherein the collation processing procedure successively stores in a temporary storage table data that are detected in the process of collating the data contained in the document data with the automaton, and outputs data stored in the temporary storage table at the time point when the collation is finished.

4. The computer-readable recording medium according to claim 1, further comprising: a numerical value transforming procedure transforming the document data stored in the storage device and the respective element identifiers contained in the search formula to numerical values.

5. An collation processing device, the device comprising:
document storage unit storing document data having a hierarchical structure in which elements are sectioned by element identifiers;
axis transforming unit executing axis transformation on a search formula for searching data contained in the document data stored in the document storage unit when the search formula is obtained, whereby the search formula concerned is transformed to a search formula constructed of child axes;
automaton creating unit identifying the type of element identifiers contained in the search formula transformed by the axis transforming unit to create an automaton corresponding to the search formula concerned; and
collating processing unit collating in order the data contained in the document data with the automaton to output the data corresponding to the search formula.

6. An collation processing method executed by a computer, the method comprising:
storing into a storage device document data having a hierarchical structure in which elements are sectioned by element identifiers;
executing axis transformation on a search formula for searching data contained in the document data stored in the storage device when the search formula concerned is obtained so that the search formula concerned is transformed to a search formula constructed of child axes;
identifying the kind of element identifiers contained in the search formula transformed to create the automaton corresponding to the search formula concerned; and
collating in order the data contained in the document data with the automaton and outputting the data corresponding to the search formula concerned.
